(19) United States
(12) Patent Application Publication
(10) Pub. No.: US 2026/0043501 A1
(43) Pub. Date: Feb. 12, 2026

(54) ANTI-ROTATION APPARATUS AND METHOD AND A PIPE ASSEMBLY AND A SYSTEM HAVING SAME

(71) Applicant: Westlake Pipe & Fittings Corporation, Houston, TX (US)

(72) Inventors: George Ferguson, Wayne, PA (US); Joshua E. Clapper, Downingtown, PA (US); Thomas Soper, Wayne, PA (US); Roy L. Dean, Schwenksville, PA (US); Dmitry Yashin, Haverford, PA (US); Andrew Wells, Wayne, PA (US); Austin Bragg, Wayne, PA (US); Andrew Schlosser, Wayne, PA (US); Harrison Connors, Wayne, PA (US); Jake Hostrander, Wayne, PA (US)

(21) Appl. No.: 19/297,956

(22) Filed: Aug. 12, 2025

Related U.S. Application Data
(60) Provisional application No. 63/682,036, filed on Aug. 12, 2024.

(51) Int. Cl. F16L 21/08

(52) U.S. Cl. CPC F16L 21/08

(57) ABSTRACT

An anti-rotation apparatus for a pipe joint includes: a stop piece having a body with a retaining portion and a locking part; a first joint part and a second joint part coupled to one another and having an axis in a lengthwise direction of the pipe joint; a locking receptacle provided in the first joint part; and a receiving receptacle provided in the second joint part. The retaining portion is disposed in the receiving receptacle of the second joint part. The locking part protrudes and is movable in a radial direction relative to the axis. When the locking part and the locking receptacle are rotationally aligned, the locking part is disposed in the locking receptacle of the first joint part and relative rotation about the axis between the first joint part and the second joint part is prevented.

### RELATED APPLICATION DATA

This patent is entitled to the benefit of and claims priority to co-pending U.S. Provisional Application Ser. No. 63/682,036 filed Aug. 12, 2024, and entitled “Anti-Rotation Apparatus and Method and a Pipe Assembly and a System Having Same.” The entire contents of this prior filed application are hereby incorporated herein by reference.

### BACKGROUND

### 1. Field of the Disclosure

The present disclosure is generally directed to pipe joints, and more particularly to an anti-rotation feature for a joint connecting pipe sections along a string of pipe.

### 2. Description of Related Art

Pipe formed from plastic material has become common for use in private residences, commercial facilities, and municipalities. Plastic pipe is often made from poly-vinyl chloride (PVC). Pipe sections are joined together at pipe joints to form extended lengths or a string of pipe for myriad uses. The pipe joints in some instances are fixed whereby the pipe sections and the pipe joints are plastic welded or permanently bonded together. However, in many installations and uses, the pipe sections are connected to one another using pipe joints whereby the pipes and joints are separable and/or movable relative to one another.

A typical pipe connection at a pipe joint in these types of pipe systems allows for some axial movement and rotation among the pipe sections and the pipe joints. In some applications, this is acceptable or even desired, particularly for pipe systems whereby the components are completely static. However, rotation among the pipe system components can be unfavorable or problematic for a large variety of piping applications, particularly where rotational forces may be applied to the string of pipe.

A primary example of such a system is known as a drop pipe system. A drop pipe system may extend down into the ground below the water table for pumping water to the surface. A pump is installed and connected at or near the bottom of the string of pipe. A power line or cable is run along the length of the pipe from a power source above ground down to the pump. During operation, the pump exerts a rotational force, i.e., torque to the pipe and can spin the pipe joints and/or the pipe sections relative to one another along the string of pipe. Over time, this can result in the power cable to the pump wrapping around the pipe and eventually disconnecting or splitting. Power loss to the pump will result once the cable is disconnected or splits or breaks.

### SUMMARY

In one embodiment according to the teachings of the present disclosure, an anti-rotation apparatus is disclosed for a pipe joint. The anti-rotation apparatus includes a stop piece having a body with a retaining portion and a locking part. A first joint part and a second joint part are coupled to one another and have an axis in a lengthwise direction of the pipe joint. A locking receptacle is provided in the first joint part, and a receiving receptacle is provided in the second joint part. The retaining portion of the body of the stop piece is disposed in the receiving receptacle of the second joint part and the locking part protrudes and is movable in a radial direction relative to the axis. When the locking part and the locking receptacle are rotationally aligned, the locking part is disposed in the locking receptacle of the first joint part and relative rotation about the axis between the first joint part and the second joint part is thereby prevented.

In one embodiment, the first joint part can be a spigot end of a first pipe, and the second joint part can be a belled end of a second pipe. The spigot end can be disposed in the belled end and the axis can be center axis of the first and second pipes.

In one embodiment, the receiving receptacle can be a hole through a wall of the second joint part.

In one embodiment, the receiving receptacle can include two holes through a wall of the second joint part and spaced apart from one another.

In one embodiment, the receiving receptacle can include two holes, which can be spaced apart from one another in an axial direction on the second joint part.

In one embodiment, the locking receptacle can include one or more locking grooves in a wall of the first joint part.

In one embodiment, the one or more locking grooves each can have a finite length and extend in an axial direction on the first joint part. The finite length can be adequate to receive the locking part of the stop piece therein.

In one embodiment, the body of the stop piece of the anti-rotation apparatus can include: a base having a length and opposed ends, at least a portion of the base defining the locking part; two posts, one protruding from the base at each of the opposed ends; a catch protrusion protruding from each of the two posts, the two posts and the catch protrusions defining the retaining portion; and one or more spring fingers connected to and protruding from a mid-portion of the base between the two posts.

In one embodiment according to the teachings of the present disclosure, a method is disclosed for forming a pipe joint, which has an anti-rotation feature and an axis. The method includes providing a first joint part having one or more locking grooves formed in an outer surface of the first joint part. The method also includes installing a retaining portion of a body of a stop piece into a receiving receptacle of a second joint part, whereby a locking part of the body protrudes from an inner surface of the second joint part and is movable in a radial direction. The method further includes inserting the first joint part into the second joint part to an extent that the locking part and the one or more locking grooves are circumferentially aligned with one another. When the locking part is not yet axially aligned with any of the one or more locking grooves, the method includes facilitating rotation of the first joint part and the second joint part relative to one another until the locking part engages one of the one or more locking grooves, thereby preventing relative rotation about the axis between the first joint part and the second joint part.

In one embodiment, the body of the stop piece of the method can include: a base having a length and opposed ends, at least a portion of the base defining the locking part; two posts, one protruding from the base at each of the opposed ends; a catch protrusion protruding from each of the two posts, the two posts and the catch protrusions defining the retaining portion; and one or more spring fingers connected to and protruding from a mid-portion of the base between the two posts. The step of installing can include installing the two posts through the receiving receptacle. The step of inserting can include the outer surface of the first joint part forcing the locking part radially outward against a bias force of the one or more spring fingers. The bias force of the one or more spring fingers can bias the locking part into the one of the one or more locking grooves.

In one embodiment according to the teachings of the present disclosure, a pipe joint assembly includes a first pipe having a first pipe first end and a first pipe second end. The first pipe first end defines a spigot end of the first pipe. The assembly also includes a second pipe having a second pipe first end and a second pipe second end. The second pipe second end defines a belled end of the second pipe and the spigot end of the first pipe is inserted into the belled end of the second pipe. The assembly further includes an anti-rotation apparatus configured to prevent relative rotation between the first pipe and the second pipe. The anti-rotation apparatus includes a stop piece installed in a radial direction through a wall of the belled end of the second pipe, and a locking part of the stop piece is received in a locking groove in an outer surface of a wall of the spigot end of the first pipe.

In one embodiment, the body of the stop piece of the pipe joint assembly can include: a base having a length and opposed ends, at least a portion of the base defining the locking part; two posts, one protruding from the base at each of the opposed ends; a catch protrusion protruding from each of the two posts, the two posts and the catch protrusions defining the retaining portion; and one or more spring fingers connected to and protruding from a mid-portion of the base between the two posts.

In one embodiment according to the teachings of the present disclosure, a drop pipe system includes a pump configured to be installed below ground, at least one power cord configured to extend from above ground level to the pump below ground level and to deliver power for operating the pump, and a pipe string including a plurality of pipes. The pipe string has one end connected to the pump and another end accessible near ground level. A first pipe of the plurality of pipes has a first pipe first end and a first pipe second end, and a second pipe of the plurality of pipes has a second pipe first end and a second pipe second end. The first pipe first end is connected to the second pipe second end to form a pipe joint. An anti-rotation apparatus at the pipe joint is configured to prevent relative rotation between the first pipe and the second pipe when the pump is operated. The anti-rotation apparatus includes a stop piece installed in a radial direction through a wall the pipe joint, and a locking part of the stop piece is received in a locking groove in an outer surface of another wall of the pipe joint.

In one embodiment, the pipe joint system can also include a separate coupler between and connecting the first pipe first end to the second pipe second end.

In one embodiment, the first pipe first end can be a spigot end, the second pipe second end can be a belled end, and spigot end of the first pipe can be directly received within the belled end of the second pipe.

In one embodiment, the body of the stop piece of the drop pipe system can include: a base having a length and opposed ends, at least a portion of the base defining the locking part; two posts, one protruding from the base at each of the opposed ends; a catch protrusion protruding from each of the two posts, the two posts and the catch protrusions defining the retaining portion; and a biasing element connected to and protruding from a mid-portion of the base between the two posts.

In one embodiment, the biasing element can include a pair of spring fingers protruding from the base and generally toward one another and away from the base between the two posts.

### BRIEF DESCRIPTION OF THE DRAWINGS

The drawings provided herewith illustrate examples or embodiments of the disclosure and therefore should not be considered as limiting the scope of the disclosure. There may be other examples and embodiments that may be equally effective to achieve the objectives and that may fall within the scope of the disclosure. Objects, features, and advantages of the present disclosure should become apparent to those having ordinary skill in the art upon reading the following description in conjunction with the drawing figures, in which:

FIG. 1 shows a generic schematic view of a drop pipe system for which the anti-rotation aspects of the present disclosure are well suited.

FIG. 2 shows an exploded perspective view of one example of a pipe joint assembly with an anti-rotation apparatus according to the teachings of the present disclosure.

FIG. 3 shows a partially exploded perspective view of the pipe joint assembly of FIG. 1 and prior to assembly of the joint.

FIG. 4 shows a lengthwise perspective view and partial cross section of the pipe joint assembly of FIG. 3.

FIGS. 5A-5D show various views of one example of an anti-rotation stop or insert piece according to the teachings of the present disclosure and for the pipe joint assembly of FIGS. 2-4.

FIG. 6 shows a cross-section of the unassembled pipe joint assembly of FIG. 3.

FIG. 7 shows the pipe joint assembly of FIG. 6 but during assembly of the joint.

FIG. 8 shows the pipe joint assembly FIGS. 6 and 7 but with the joint fully assembled and the anti-rotation apparatus locked.

FIG. 9 shows a view, partially cut away, of the pipe joint assembly of FIG. 7 according to the teachings of the present disclosure.

FIG. 10 shows an exploded perspective view of another example of a pipe joint assembly according to the teachings of the present disclosure and with the ani-rotation stop or insert piece of FIGS. 5A-5D.

FIG. 11 shows a perspective view of the pipe joint assembly of FIG. 10 but fully assembled.

FIG. 12 shows a side view of another example of an anti-rotation stop or insert piece according to the teachings of the present disclosure and for a pipe joint assembly as disclosed and described herein.

The use of the same reference numbers or characters throughout the written description and drawings indicates similar or identical components, aspects, and features of the disclosure.

### DETAILED DESCRIPTION OF THE DISCLOSURE

An aspect of the present disclosure is to solve or improve upon one or more of the above-noted problems with prior known pipes and pipe joints. According to the embodiments of the present disclosure, a separate component, device, feature, or the like, i.e., the anti-rotation stop or insert piece is incorporated in a pipe joint. In the disclosed embodiments, the insert is incorporated in a female end, i.e., in a belled end of a pipe or in a pipe coupling or pipe joint. The insert or stop piece is recessed in the female end in a manner to allow for insertion of a male end, i.e., a spigot end, of another pipe of the pipe joint.

In the disclosed embodiments, either in the correct rotational orientation or during initial allowable rotation of the pipe, the insert is configured to automatically engage with one or multiple features on the male end of the pipe that is joined to the female end in order to prevent further rotation. The disclosed solutions function independently of features of the pipe that counteract tension in the pipe joint, allowing for disassembly of the pipe joint as desired. For each of the disclosed embodiments, the size and shape of the insert may be varied based on torque requirements and/or other aspects of a given application.

The specification does not necessarily describe all elements of various embodiments of the present disclosure. Descriptions of elements or components well-known in the art to which the present disclosure pertains or overlapping or repetitive descriptions have been entirely or partly omitted.

It should be understood that, when an element is referred to as being “connected” to another element, it can be directly or indirectly connected to the other element. An indirect connection includes one or more intervening elements or parts among or between two connected elements.

It should be understood that the terms “include,” “comprise,” “have,” and the like, and variations thereof, when used in the present disclosure, specify the presence of stated features, integers, steps, operations, elements, and/or components. The terms do not preclude the presence or addition of one or more other features, integers, steps, operations, elements, components, and/or groups thereof.

It should be understood that, where it is stated in the present disclosure that an element is located “on” another element, the element may be in direct contact with the other element, or another element may yet be present between the one element “on” the other element.

It should be understood that, although the terms first, second, etc., and other such similar terms may be used herein to describe various elements, these elements should not be limited by these terms. These types of terms are used merely to distinguish among various elements, unless expressly stated to the contrary. Similarly, terms such as “up,” “upward,” “vertical,” “down,” “downward,” “forward,” “rearward,” “horizontal,” “lateral,” and the like, if used herein, are used for reference as relative directional terms. It should be understood that these types of terms are also not strictly limiting, unless expressly stated herein.

It should be understood that the use of singular forms is intended to include the plural forms as well unless the context clearly dictates otherwise. Further, when a component, device, element, or the like of the present disclosure is described as having a purpose or performing an operation, function, or the like, the component, device, or element should be considered herein as being “configured to” meet that purpose or perform that operation or function.

Reference numerals, which may be used for method steps, are used for convenience of explanation, but not to limit an order of the steps. Thus, unless the context clearly dictates otherwise, the written order may be practiced otherwise.

Hereinafter, an operation principle and embodiments of the present disclosure are described in detail with reference to the accompanying drawings. In each example, the pipe joint assembly includes a coupling or pipe joint that joins and interlocks two pipes or pipe sections to one another. Though not described in detail herein, the coupling or pipe joint may include a separate coupler that connects two pipes together and each connection between a pipe and the coupler may be configured as described herein. However, in the disclosed examples, each coupling or joint is a direct connection between two adjacent pipes or pipe sections. Aspects of the present disclosure and the embodiments described herein are described as being suitable for use in a drop pipe system. However, as should be apparent to those having ordinary skill in the art, the ani-rotation concepts can be used for other pipe joints and pipe systems as well.

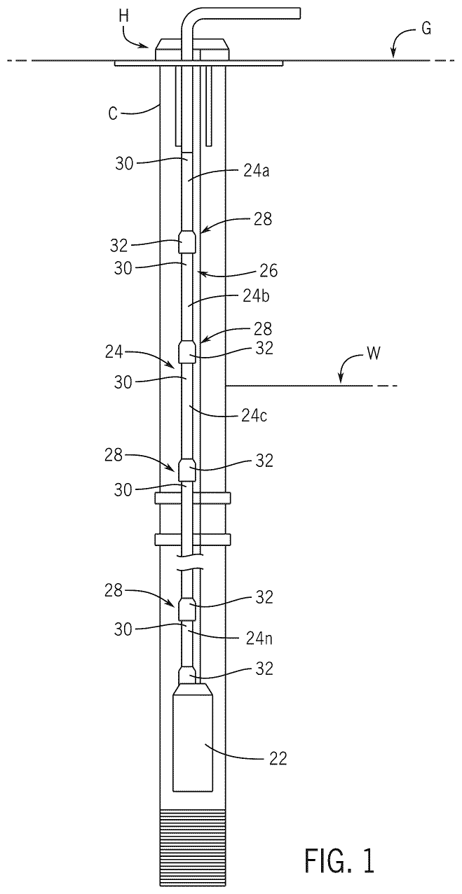

In the context of the present disclosure, and as shown in FIG. 1, a drop pipe system 20, such as for a well, has a pump 22 that is configured to be installed below ground level G, at the lower or bottom end of a drop pipe assembly or pipe string 24. The pipe string 24 and pump 22 may be received in an outer casing, such as a well casing C that keeps the surrounding ground from collapsing on the pipe string and allows ground water to reside around the pipe string up to the water table level W. The pump 22 is configured to pump fluid, such as water, from below up to ground level G or above. The system 20 has at least one power cord 26 that extends from a power source (not shown), such as a source of electricity, to the pump 22 below ground level G. The cord 26 delivers or provides power for operating the pump 22. The pipe string 24 of the system 20 may typically have a series of pipes, i.e., pipe sections or segments, which are connected end to end to form the drop pipe assembly or pipe string 24. The pipe string 24 connects the pump 22 to a part or structure (not shown) at a point, such as at a well head H, above ground level G where the water or fluid can be collected, stored, and distributed. The pipe string 24 has pipe joints 28 where each adjacent two pipes are connected to one another.

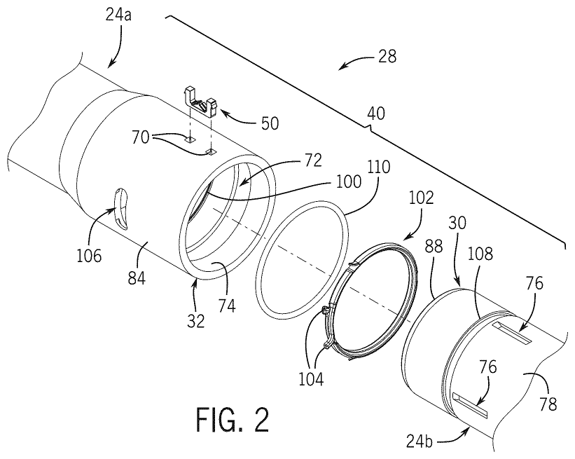

Thus, referring to FIGS. 1 and 2, the system 20 may be described as having at least a first pipe section or segment, i.e., a first pipe 24a, that has a first pipe first end 30 and a first pipe second end 32 opposite the first end. For the sake of description, the first end 30 of the first pipe 24a may be a male or spigot end of the pipe and the second end 32 of the first pipe may be a female or belled end of the pipe. However, in a particular application or use environment, this may be reversed, depending on how the pipe may attach to the pump 22, to a component C (shown only generically) at the well head H, or based on other pipe or system considerations. In this example, the component C at the well head H of the system 20, near or above ground level G, may be connected or connectable to the first end 30 of the first pipe 24a in any known manner. The system 20 also has at least a second pipe section or segment, i.e., a second pipe 24b that has a second pipe first end 30 and a second pipe second end 32. The second pipe first end 30 is connected or connectable to the second end 32 of the first pipe 24a and thus, in this example, the first end may be a male or spigot end of the second pipe. Likewise, the second end 32 of the second pipe 24b may again be a female or belled end of the second pipe. The second pipe second end 32 is connected or connectable to a first end 30 of yet another pipe, i.e., a third pipe 24c or alternatively to the pump 22 in a known manner at the bottom of the pipe string 24.

The system 20 may include any number of additional pipe sections or segments ‘n’, i.e., additional pipes 24c-24n that are connected to one another to form the pipe string 24. The number of pipes ‘n’ can vary widely depending on the length or depth of the pipe system or drop pipe system, the system requirements, the length of each pipe section or segment, and/or the like. The system 20 also may have separate couplers (not shown or described herein) that are configured to join adjacent pipe sections or segments to one another at each joint 28, thus defining a separate joint between each pipe and the coupler, instead of directly between two pipes. In the disclosed embodiments, the pipe joints 28 or couplings are formed by directly inserting a spigot end of one pipe section or segment, i.e., the first end 30 of the second pipe 24b into a belled end, i.e., the second end 32 of the first pipe 24a, without the use of a separate coupler.

According to the teachings of the present disclosure, the system 20 also has an anti-rotation apparatus at the pipe joints 28. The pipe joints 28 may include each joint between any two adjacent two pipes, a joint between a pipe and the pump 22, and/or a joint between a pipe and another component of the system, such as the component C at the well head end H of the system 20. The anti-rotation apparatus is configured to prevent relative rotation at each joint between pipes and/or or between a pipe and another part of the system, such as the pump or another component. This relative rotation can occur when the pump 22 is operated or when a torque is applied to the pipe string 24. The anti-rotation apparatus is shown and described herein at the joint 28 between the first pipe 24a and the second pipe 24b, though the apparatus can be used at any of the aforementioned joints or couplings. The anti-rotation apparatus generally includes an anti-rotation stop or insert piece and includes features provided on the joined pipe components, such as on the first pipe 24a and second pipe 24b, that accommodate and/or interact with the stop piece to prevent relative rotation between the joined parts. In the disclosed examples, the anti-rotation stop or insert piece is installed in a radial direction through at least a portion of the parts of the coupling or pipe joint 28 to rotationally interlock the first pipe 24a relative to the second pipe 24b. This anti-rotation apparatus addresses the above-described problems with prior art drop pipe and other pipe systems.

In the context of the present disclosure, the anti-rotation apparatus is provided for a pipe joint 28, which can be between the first pipe 24a and a structure, such as the component C, at the well head H near ground level G, between two pipes 24a and 24b, or between a last pipe ‘n’ and the pump 22 at the bottom free end of the pipe string 24 opposite the well head. The apparatus includes the anti-rotation stop or insert piece, which may have a body and a locking part. The anti-rotation apparatus may also be considered to include or to be incorporated into a coupling or pipe joint. The coupling or pipe joint may include a first joint part, such as a first pipe, and a second joint part, such as a second pipe, with an axis in a lengthwise direction of the coupling. The anti-rotation apparatus may also include a receiving receptacle provided in the first joint part of the coupling and a locking receptacle provided in the second joint part of the coupling. The body or a part of the body of the anti-rotation stop piece may be disposed in the receiving receptacle of the first joint part. The locking part may protrude in a radial direction relative to the axis and, when in a locked or engaged arrangement, may be disposed in the locking receptacle of the second joint part thereby preventing relative rotation about the axis between the first and second joint parts.

Referring to FIGS. 2-5D, one example of an anti-rotation apparatus 40 for a pipe joint 28 is shown. In this embodiment, the anti-rotation apparatus 40 includes a stop piece 50 or insert piece. The stop piece 50 may be made of stiff but resilient plastic or plastic-type material but other suitable materials may also be utilized. The stop piece 50 may be a single molded piece with a number of integrated features.

In this example, the stop piece 50 has a body 52 that is U-shaped or C-shaped. The body 52 includes a base portion or base 54 and two posts 56, i.e., prongs, arms, or the like. In this embodiment, the body 54 has a length from post to post, an axis along the length, a mid-portion, and two ends. The base 54 in this embodiment is generally rectangular in cross-section shape and has a pair of opposed side surfaces 51, a bottom surface 53, and a top surface 55. The two posts 56, i.e., prongs or arms, each extend from respective ends of the base 54 and have a height in a direction away from the axis of the base. The posts 56 are spaced from one another at the opposite ends of the base 54 and extend from the base in the same direction, i.e., the posts are circumferentially aligned with one another. In this example, the posts 56 are also generally parallel with one another and are generally perpendicular to the axis of the base 54. Each of the posts 56 also is generally rectangular in cross-section shape and has a pair of opposed side surfaces 51 that coincide with the side surfaces 53 of the base 54. Each post 56 also has an inward facing surface 57 that confronts the like facing surface on the other post and has an outward facing surface 59 that faces in the opposite direction.

The foregoing described geometric features and aspects of the stop piece 50 may be modified or altered within the spirit and scope of this disclosure. The stop piece 50, including the posts 56 and the base 54 of the body 52, is relatively stiff but is sufficiently flexible and resilient to function as intended and as described herein. The stop piece 50 is configured to be resilient to provide spring-type functions or to have one or more spring-like characteristics, as described below

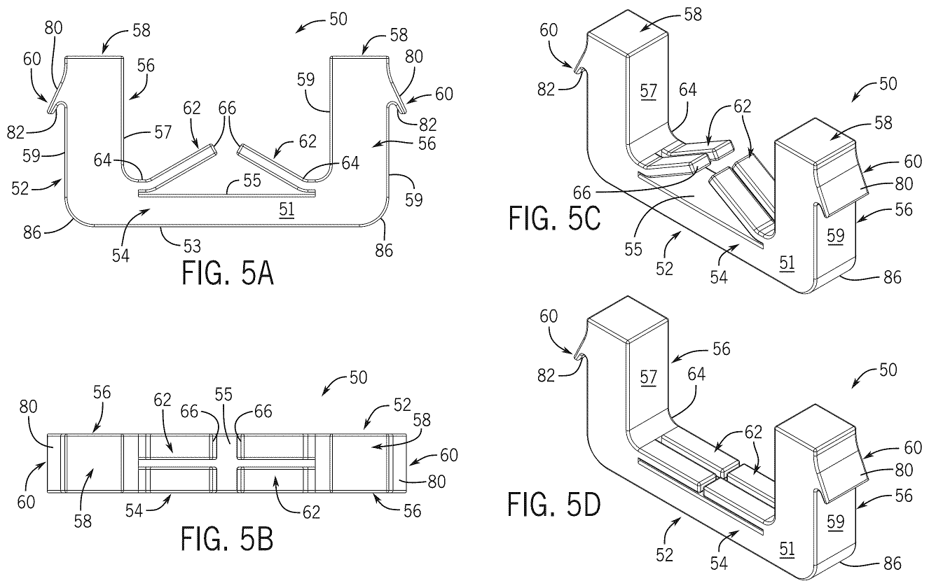

With reference to FIGS. 5A-5D, a free end 58 of each post 56 has a protrusion or catch 60, i.e., a detent feature, which extends outward from the respective post from eh outward facing surface 59. Each protrusion 60 is configured to aid in retaining the stop piece 50 on the female end of the pipe, once installed. The protrusions 60 in this example protrude from the outward facing surfaces 59 of the posts 56 in opposite directions away from one another. In other examples, the protrusions 60 may extend outward from the posts 56, but toward one another from the inward facing surfaces 57 over the base 54 or may extend outward from the side surfaces 51 of the posts in the same direction or opposite directions while still maintaining their intended function, as described below.

In this embodiment, the body 52 also has one or more, i.e., two in this example, spring fingers or resilient tabs 62 that protrude from the top surface 55 of the base 54. The spring fingers 62 are located generally on the mid-portion of the body 52 between the posts 56. Each spring finger 62 is connected to the base 54 near a corresponding one of the posts 56 and extends radially upward and axially toward the other spring finger. The spring fingers 62 are circumferentially aligned with and between the posts 56 and each has substantially the same width as the width of the base 54. The spring fingers 62 each have one end 64 integrally connected to the base 54 and one free or distal end 56 spaced from the base. As a result, the spring fingers 62 are arranged or oriented at an angle relative to the axis and the top surface 55 of the base 54 when in their relaxed or normal state, as shown in FIGS. 5A-5C. The angle may vary, as long as the spring fingers 62 have sufficient travel and are sufficiently resilient to perform their intended function, as described below. The spring fingers 62 in one example may be oriented at 30 degree angles relative to the base, or at greater angles (i.e., 45 degrees, 35 degrees, or the like) or lesser angles (i.e., 15 degrees, 25 degrees, or the like), as generally depicted in FIG. 5A. Once the stop piece 50 is installed, the spring fingers 62 may be forcibly bent from the relaxed state toward the base 54, as depicted in FIG. 5D (showing the spring fingers fully bent into contact with the base). The length of the spring fingers 62 in this embodiment is such that their ends do not touch each other when bent onto the base top surface 55. The spring fingers 62 provide a resilient spring action or biasing function, when bent toward the base 54, that biases or forces the stop piece 50 toward a stop position as described below.

With reference to FIGS. 2-4 and 6, the anti-rotation apparatus 40 also includes a receiving receptacle in one of the joint parts for installing or receiving one of the stop pieces. In this embodiment, the first joint part is the female end or belled end, i.e., the second end 32 of the pipe 24a. In this embodiment, the receiving receptacle is provided in the form of a pair of holes 70 through the wall of the pipe 24a for receiving the posts 56 of the stop piece 50. Since the posts 56 are rectangular in cross-section, the holes 70 are also rectangular in shape. If more than one stop piece 50 is used, or if more than one installation location option is desired, the female end 32 of the pipe 24a would include multiple receiving receptacles, i.e., multiple sets of the holes 70, at least one set for each stop piece. For the anti-rotation function, however, only one stop piece 50 and one pair of holes 70 need be provided.

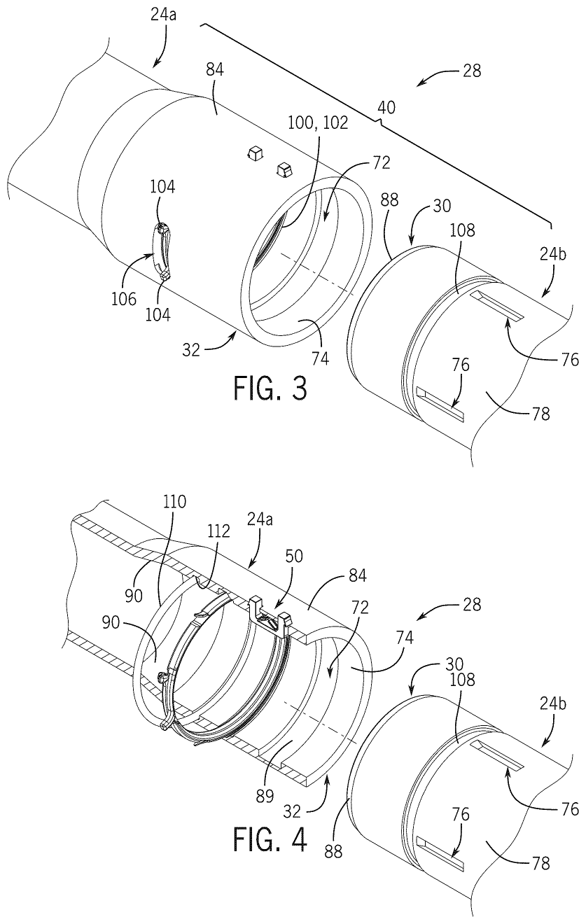

The anti-rotation apparatus 40, and more specifically, the receiving receptacle, also includes a recess or groove that is formed along the inner surface of the same one of the joint parts that has the receiving receptacle for the stop piece. In this embodiment, the first joint part is again the female or belled end, i.e., the second end 32 of the first pipe 24a. A recess or groove 72 is provided to allow the stop piece 50 to be moved radially to facilitate assembly of a pipe joint 28, as described below. The recess or groove 72 may be formed as a local recess, only to coincide with the circumferential position of the pair of holes 70, or may be formed as a groove, to extend completely circumferentially around the inner surface 74, as shown in the embodiment depicted in FIGS. 3, 4, and 6. The recess or groove 72 also is positioned axially on the inner surface 74 of the first pipe 24a to coincide with the axial position of the holes 70 and has an axial length dimension or width sufficient to extend between the two holes, i.e., at least as wide as the spacing between the posts 56 of the stop piece 50. The depth into the inner surface 74 of the recess or groove 72 is such that the base 54 of the body 52 of the stop piece 50 can be moved radially outward into the recess or groove to the degree needed to allow formation of the pipe joint 28, as described below.

The anti-rotation apparatus 40 further includes a locking receptacle that is formed on the other of the joint parts that interacts with the stop piece to prevent relative rotation between the joint parts. In this embodiment, the other joint part is the male or spigot end, i.e., the first end 30 of the second pipe 24b. In this embodiment, the locking receptacle is provided in the form of one or more blind slots or grooves, i.e., locking grooves 76 formed along an outer surface 78 of the spigot or male end, i.e., the first end 30 of the second pipe 24b. Each blind locking groove 76 is recessed into the outer surface 78 of the second pipe 24b and is formed to extend in a lengthwise or axial direction along the second pipe 24b. The length of the locking groove or grooves 76 is sufficient to accommodate the length of the locking part, i.e., the base 54 of the stop piece. Further, the depth of the locking groove or grooves 76 is adequate enough to receive at least a portion of a height of the base 54 that is sufficient to perform the anti-rotation locking function described herein.

In one embodiment, one stop piece 50 and one locking groove may be provided in a given anti-rotation apparatus. In another embodiment, one stop piece 50 and multiple locking grooves 76 may be provided. In yet another embodiment, the same number of two or more locking pieces 50 and two or more locking grooves 76 may be provided. Though perhaps not economical, more stop pieces 50 could be provided than locking grooves 76, but then one or more stop pieces would not be utilized or seated in a locking groove 76 during use. If two or more locking grooves 76 are provided on the pipe, the grooves 76 may be spaced apart in a circumferential direction around the pipe and may be spaced equidistant from one another around the pipe circumference. With more than one locking groove 76, more than one anti-rotation landing spot is provided. This will require less rotation between the female or belled end and the male or spigot end during installation or assembly of the pipe joint 28 before a stop piece 50 engages one of the locking grooves 76 to rotationally lock the two joint parts together. In one example, if four locking grooves 76 are provided, less than 90 degrees of relative rotation between the two pipes 24a and 24b is required to engage the anti-rotation apparatus 40.

In this embodiment, the stop piece is installed in one of the pipe joints and then the anti-rotation feature will automatically lock upon rotation of one joint part relative to the other joint part. Referring to FIGS. 2-6, the stop piece 50 is first installed by inserting the posts 56 through the corresponding holes 70 from the inside of the second end 32 of the first pipe 24a. The stop piece 50 should “snap” into place through the holes 70 via resiliency of the posts 56 and/or base 54 and/or resiliency of the protrusions 60 or retention features. In this embodiment, the posts 56 can move toward one another as the protrusions 60 clear the pipe material within the holes 70. The protrusions 60 can have a ramped or wedge shaped face 80 on the top side, which allows the posts 56 to be forcibly pushed through the holes 70. An underside or catch face 82 of the protrusions 60 can be flat or undercut and catch, i.e., bear against an outer surface 84 of the second end 32 on the first pipe 24a. Thus, once installed, the protrusions 60 will retain the stop piece in place by preventing the posts 56 from free falling or being pushed back through the holes 70. In this example, the protrusions 60 are provided on the outward facing sides 59 of the posts 56. Thus, if one wanted to remove the stop piece 50, the posts 56 could be squeezed toward one another to provide clearance for the protrusions 60 to pass in a reverse direction back through the holes 70.

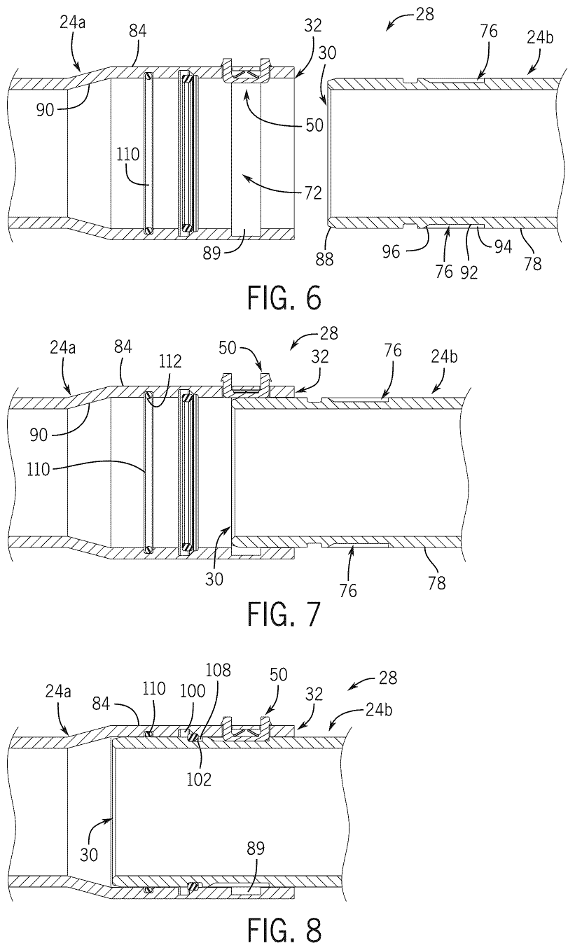

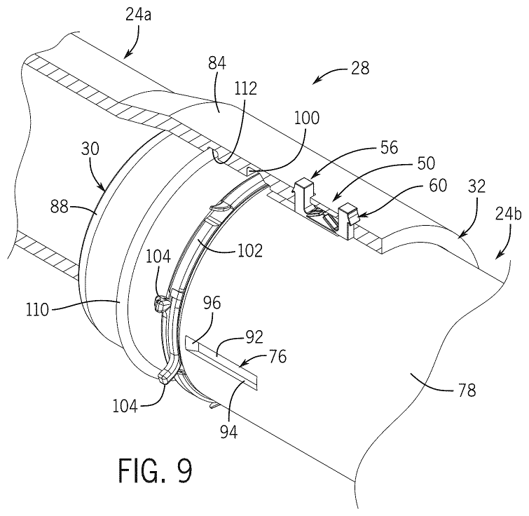

Referring to FIGS. 6-9, the pipe joint 28 is assembled by inserting the male or spigot end, i.e., the first end 30 of the second pipe 24b into the female or belled end, i.e., the second end 32 of the first pipe 24a. See FIGS. 6 and 7. The stop piece 50, such as the lengthwise edges 86 on the bottom surface 53 of the base 54 on the body 52, and/or a leading end 88 of the spigot or male end, i.e., the first end 30 of the second pipe 24b may be ramped or chamfered. This can allow the first pipe 24a to readily pass the stop piece 50 during pipe insertion. See FIGS. 5A, 6, and 7. When outward radial force is applied to the base 54 of the stop piece 50 via the outer surface 78 of the second pipe 24b, the base 54 is pushed radially outward into the recess or groove 72. The spring fingers 62 or tabs are pressed and forced by the groove surface 89 toward the base 54 of the body 52 on the stop piece 50, allowing the stop piece to move radially outward. As the second pipe 24b is pushed into the first pipe 24a, the base 54 on the body 52 of the stop piece 50 is received in the recess or groove 72 in the inner surface 74 of the belled end or second end 32 of the first pipe 24a. This allows the second pipe 24b to be fully received in the first pipe 24a, such as is shown in FIGS. 8 and 9.

This also aligns the one or more locking grooves 76 on the outer surface 78 of the second pipe 24b with the one or more stop pieces 50 in the axial direction. Thus, the anti-rotation apparatus 40 is ready to engage, though the one or more locking grooves 76 are likely still mis-aligned rotationally with the one or more stop pieces 50. The axial insertion amount of the second pipe 24b into the first pipe 24a can be designed to automatically set and axially align the parts of the anti-rotation apparatus. This can be achieved by a precise length of the spigot end or first end 30 of the second pipe 24b being received in the belled end or second end 32 of the first pipe 24a before hitting a stop 90. In this embodiment, the stop 90 is created by the location at which the diameter defined by the inner surface 74 of the belled end or second end 32 of the first pipe 24a decreases to the nominal pipe diameter beyond the bell. See FIGS. 7 and 8.

As noted above, when the first end 30 of the second pipe 24b is fully inserted into the second end 32 of the first pipe 24a, as in FIG. 8, it is still very likely that the one or more locking grooves 76 and the one or more stop pieces 50 are not rotationally aligned. Thus, the stop piece 50 would still be compressed into the recess or groove 72, depicted in FIG. 7. The pipes can then be rotated about the pipe axis relative to one another. This can be done manually at the time of assembling the pipe joint 28. Alternatively, this can be done organically or automatically during operation. In other words, if one pipe rotates relative to another pipe upon a torque input, such as through operation of a motor of the pump 22 described above, the pipes will only rotate until the anti-rotation apparatus engages.

Once the locking groove 76, or one of the locking grooves, in the spigot or male end, i.e., the first end 30 of the second pipe 24b is rotationally aligned with the stop piece 50, or one of the stop pieces, the spring fingers 62 or tabs will force, i.e., fire the stop piece into the aligned locking groove. The base 54 of the stop piece 50 resides in the locking groove 76 with the base borne against or adjacent a groove bottom 92. The side walls 51 of the base 54 are seated between groove sides 94 of the locking groove 76. See FIGS. 8 and 9. This arrangement captures the base 54 of the stop piece 50 between the groove walls 94, which engages the anti-rotation apparatus and creates a lock or interference that prevents relative rotation of the pipes 24a and 24b.

The rotational alignment can be achieved from immediate assembly of the pipe joint or after the pipes are rotated relative to one another until the locking groove and stop piece align. Because of this, the bell/spigot joint can be assembled in any relative rotational alignment. The two pipes or joint parts can be manually rotated to engage the locking feature, or the rotation can be allowed to occur naturally or organically during use. Once engaged, the pipe joint components are prevented from further rotating relative to one another. See FIG. 9. A chamfer or gradual slope or ramp 96 on one end of the locking groove 76 or grooves, i.e., the leading end of the groove during assembly and the trailing end of the groove during disassembly, can allow for unrestricted axial disassembly of the pipe joint 28. The stop piece 50 would be pushed radially outward out of the locking groove 76 and into the recess or groove 72 by the outer surface 78 on the second pipe 24b as the second pipe and the first pipe 24a are pulled apart. See FIG. 7.

As noted above, the stop piece 50 can be formed of any suitable material, such as various plastic materials, as long as it can function as described above. The shape of the body 52, including the base part or base 54 and the posts or prongs 56 can also vary, as can the number, size, orientation, position, type, and shape of the protrusions 60 and spring tabs or fingers 62.

The integrity of the pipe joint 28 in the lengthwise direction can be axially retained in any suitable manner, and independent of the anti-rotation apparatus 40 described and disclosed herein. The joint 28 is axially retained in the above described embodiment of FIGS. 2-9 using the patent owner's CERTA-LOK CLIC technology and components, which employ an automatic spline locking feature.

Briefly, a spline groove 100 is provided on the inner surface 74 of the belled end or second end 32 of the first pipe 24a. A squeezable retainer ring or spline 102 is seated in the spline groove 100 and has squeeze tabs 104 that can be used to manually expand the ring diameter. The squeeze tabs 104 protrude from an aperture 106 in the wall of the belled end or second end 32. A corresponding retainer groove 108 is provided on the outer surface 78 of the spigot or first end 30 of the second pipe 24b. The spline groove 100 and retainer groove 108, as well as the spline 102, are cooperatively shaped, as is known, so that the spline 102 automatically locks and axially retains the two pipes 24a and 24b in the engaged state. A seal 110, i.e., a gasket or O-ring, can also be seated in a seal groove 112, which may be provided on one of the joint parts, such as on the inner surface 74 of the belled second end 32 of the first pipe 24a. To release the pipe joint 28, the tabs 104 of the spline 102 can be squeezed together within the aperture 106. This expands the diameter of the spline 102, releasing it from the retainer groove 108, and permitting the pipes 24a and 24b to be pulled apart. The anti-rotation apparatus 40 will not prevent axial separation of the pipes 24a and 24b because the ramp 96 of the locking groove 76 allows axial movement of the stop piece 50 when rotationally locked, as described above.

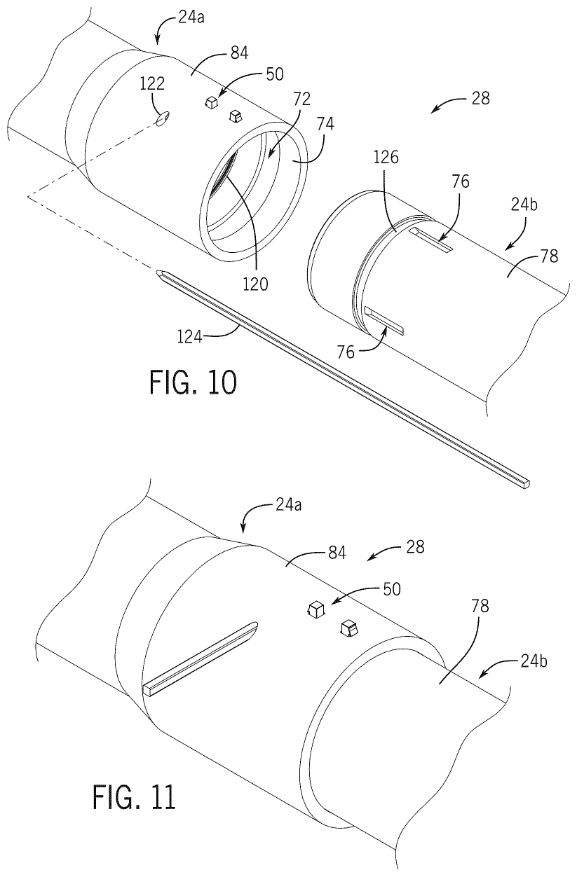

As shown in FIGS. 10 and 11, the pipe joint 28 can be axially retained using other methods. In one example, the pipe joint 28 can be axially retained using the patent owner's CERTA-LOK spline technology and components, which are manually installed. Briefly, a spline groove 120 is again provided on the inner surface 74 of the belled end or second end 32 of the first pipe 24a. An opening 122 is provided through the wall of the belled second end 32 of the first pipe 24a and is aligned with the spline groove 120. An elongate, stiff but flexible spline 124 is also provided. A corresponding retainer groove 126 is again provided on the outer surface 78 of the spigot or first end 30 of the second pipe 24b. The spline groove 120 and retainer groove 126, as well as the spline 102, are again cooperatively shaped, as is known. When the two pipes 24a and 24b are assembled, the spline 124 is manually inserted through the opening 122 into the now axially aligned spline groove 120 and retainer groove 126. The spline 124 locks and axially retains the two pipes 24a and 24b in the engaged state. Though not shown in this embodiment, a seal, i.e., a gasket or O-ring, can also be seated in a seal groove, which may be provided on one of the joint parts. To release the pipe joint 28, an exposed tail of the spline 124, protruding outside the pipe joint 28 as shown in FIG. 11, can be forcibly pulled to withdraw the spline from the grooves 120 and 126. This eliminates the retention feature, permitting the pipes 24a and 24b to be pulled apart. The anti-rotation apparatus 40 again will not prevent axial separation of the pipes 24a and 24b because the ramp 96 of the locking groove 76 allows axial movement of the stop piece 50 when rotationally locked, as described above. Still other joint retainer configurations may also be used, independent of the disclosed anti-rotation feature.

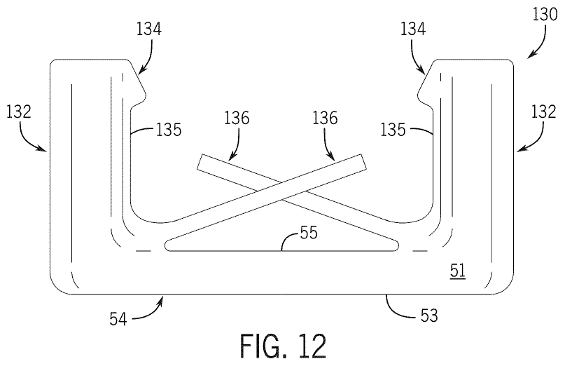

As noted above, the stop piece can vary in configuration and construction. FIGS. 12A and 12B illustrate one modified example of a stop piece 130. In this embodiment, the stop piece 130 has a body 132 with a base that may be identical to the earlier described base 54. The body also has posts 132 that are different from the earlier described posts 56. In this embodiment, each post has a protrusion 134 that protrudes from an inward facing surface 135. Thus, when the stop piece 130 is installed in the holes 70, the posts will move outward away from one another until the protrusions pass through the holes. The cross-section shape of the posts 132 in this embodiment is also modified. Each post 132 has flat side surfaces 51 that coincide with the side surfaces of the base 54, a rounded outward facing surface, and a partly rounded and partly flat inward facing surface 135, with the protrusions provided on the flat portion. The stop piece 130 in this embodiment also has modified spring fingers 136. In this embodiment, each spring finger 136 is only half as wide as the base width and extends further toward the opposite post 132. Thus, the spring fingers 136 cris-cross one another at the mid-portion of the base 54. The spring characteristics of the spring fingers and the body can thus be altered by changing various features of each component.

Other variations and modifications to the anti-rotation apparatus components are certainly possible within the spirit and scope of the present disclosure. The various recess and groove shapes, sizes, dimensions, and quantity can be changed. The receiving receptacle may include only a single hole, and the stop piece may include only a single post or may include two or more posts configured to fit within the single hole. The two receiving holes may be spaced apart in the circumferential direction, not the axial direction, and the stop piece may have a complimentary shaped base. Other variations and modifications to the receiving and locking receptacles and the stop piece are also possible. Further, any pipe joint described herein can be configured at least in part on a pipe, a pipe coupler, or a component to which a pipe or coupler might be attached, such as a pump or motor or a component at a well head. It should be understood that any one of the features, aspects, characteristics, components, arrangements, and the like may be utilized, alone or in any combination with any of the disclosed embodiments and with any other of the features, aspects, characteristics, components, arrangements, and the like.

Although certain anti-rotation apparatus and method examples, and pipe assembly and system examples, have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. An anti-rotation apparatus for a pipe joint, the apparatus comprising:
a stop piece having a body with a retaining portion and a locking part;
a first joint part and a second joint part coupled to one another and having an axis in a lengthwise direction of the pipe joint;
a locking receptacle provided in the first joint part; and
a receiving receptacle provided in the second joint part,
wherein the retaining portion of the body of the stop piece is disposed in the receiving receptacle of the second joint part,
wherein the locking part protrudes and is movable in a radial direction relative to the axis, and
wherein, when the locking part and the locking receptacle are rotationally aligned, the locking part is disposed in the locking receptacle of the first joint part, relative rotation about the axis between the first joint part and the second joint part is prevented.

2. The anti-rotation apparatus of claim 1, wherein the first joint part is a spigot end of a first pipe, wherein the second joint part is a belled end of a second pipe, wherein the spigot end is disposed in the belled end, and wherein the axis is a center axis of the first and second pipes.

3. The anti-rotation apparatus of claim 1, wherein the receiving receptacle comprises a hole through a wall of the second joint part.

4. The anti-rotation apparatus of claim 1, wherein the receiving receptacle comprises two holes through a wall of the second joint part and spaced apart from one another.

5. The anti-rotation apparatus of claim 4, wherein the two holes are spaced apart from one another in an axial direction on the second joint part.

6. The anti-rotation apparatus of claim 1, wherein the locking receptacle comprises one or more locking grooves in a wall of the first joint part.

7. The anti-rotation apparatus of claim 6, wherein the one or more locking grooves each has a finite length and extends in an axial direction on the first joint part, and wherein the finite length is adequate to receive the locking part of the stop piece therein.

8. The anti-rotation apparatus of claim 1, wherein the body of the stop piece comprises:
a base having a length and opposed ends, at least a portion of the base defining the locking part;
two posts, one protruding from the base at each of the opposed ends;
a catch protrusion protruding from each of the two posts, the two posts and the catch protrusions defining the retaining portion; and
one or more spring fingers connected to and protruding from a mid-portion of the base between the two posts.

9. A method of forming a pipe joint having an anti-rotation feature and an axis, the method comprising:
providing a first joint part having one or more locking grooves formed in an outer surface of the first joint part;
installing a retaining portion of a body of a stop piece into a receiving receptacle of a second joint part, whereby a locking part of the body protrudes from an inner surface of the second joint part and is movable in a radial direction;
inserting the first joint part into the second joint part to an extent that the locking part and the one or more locking grooves are circumferentially aligned with one another; and
when the locking part is not yet axially aligned with any of the one or more locking grooves, facilitating rotation of the first joint part and the second joint part relative to one another until the locking part engages one of the one or more locking grooves, thereby preventing relative rotation about the axis between the first joint part and the second joint part.

10. The method of claim 9, wherein:
the body of the stop piece includes
a base having a length and opposed ends, at least a portion of the base defining the locking part,
two posts, one protruding from the base at each of the opposed ends,
a catch protrusion protruding from each of the two posts, the two posts and the catch protrusions defining the retaining portion, and
one or more spring fingers connected to and protruding from a mid-portion of the base between the two posts;
the step of installing includes installing the two posts through the receiving receptacle;
the step of inserting includes the outer surface of the first joint part forcing the locking part radially outward against a bias force of the one or more spring fingers; and
wherein the bias force of the one or more spring fingers biases the locking part into the one of the one or more locking grooves.

11. A pipe joint assembly comprising:
a first pipe having a first pipe first end and a first pipe second end, the first pipe first end defining a spigot end of the first pipe;
a second pipe having a second pipe first end and a second pipe second end, the second pipe second end defining a belled end of the second pipe, the spigot end of the first pipe inserted into the belled end of the second pipe; and
an anti-rotation apparatus configured to prevent relative rotation between the first pipe and the second pipe,
wherein the anti-rotation apparatus includes a stop piece installed in a radial direction through a wall of the belled end of the second pipe, and
wherein a locking part of the stop piece is received in a locking groove in an outer surface of a wall of the spigot end of the first pipe.

12. The pipe joint assembly of claim 11, wherein the body of the stop piece comprises:
a base having a length and opposed ends, at least a portion of the base defining the locking part;
two posts, one protruding from the base at each of the opposed ends;
a catch protrusion protruding from each of the two posts, the two posts and the catch protrusions defining the retaining portion; and
one or more spring fingers connected to and protruding from a mid-portion of the base between the two posts.

13. A drop pipe system comprising:
a pump configured to be installed below ground;
at least one power cord configured to extend from above ground level to the pump below ground level and to deliver power for operating the pump;
a pipe string including a plurality of pipes, the pipe string having one end connected to the pump and another end accessible near ground level;
a first pipe of the plurality of pipes having a first pipe first end and a first pipe second end;
a second pipe of the plurality of pipes having a second pipe first end and a second pipe second end, the first pipe first end connected to the second pipe second end to form a pipe joint; and
an anti-rotation apparatus at the pipe joint configured to prevent relative rotation between the first pipe and the second pipe when the pump is operated,
wherein the anti-rotation apparatus includes a stop piece installed in a radial direction through a wall the pipe joint, and
wherein a locking part of the stop piece is received in a locking groove in an outer surface of another wall of the pipe joint.

14. The pipe joint system of claim 13, further comprising a coupler between and connecting the first pipe first end to the second pipe second end.

15. The pipe joint system of claim 13, wherein the first pipe first end is a spigot end, wherein the second pipe second end is a belled end, and wherein the spigot end of the first pipe is directly received within the belled end of the second pipe.

16. The pipe joint system of claim 13, wherein the body of the stop piece comprises:
a base having a length and opposed ends, at least a portion of the base defining the locking part;
two posts, one protruding from the base at each of the opposed ends;
a catch protrusion protruding from each of the two posts, the two posts and the catch protrusions defining the retaining portion; and
a biasing element connected to and protruding from a mid-portion of the base between the two posts.

17. The pipe joint system of claim 16, wherein the biasing element comprises a pair of spring fingers protruding from the base and generally toward one another and away from the base between the two posts.
